(19) United States
(12) Patent Application Publication
(10) Pub. No.: US 2016/0109962 A1
(43) Pub. Date: Apr. 21, 2016

(54) HANDWRITING INPUT DEVICE OF ELECTRONIC DEVICE

(71) Applicant: HON HAI PRECISION INDUSTRY CO., LTD., New Taipei (TW)

(72) Inventor: CHIU-MEI LAI, New Taipei (TW)

(21) Appl. No.: 14/551,968

(22) Filed: Nov. 24, 2014

(30) Foreign Application Priority Data
Oct. 17, 2014 (CN) 201410551434.0

(51) Int. Cl. G06F 3/0354; G06F 3/038; B43K 29/00

(52) U.S. Cl. CPC G06F 3/03542; B43K 29/003; G06F 3/0386

(57) ABSTRACT

A handwriting input device includes a shell, a refill, a light emitting unit, a pressure sensing unit, a light sensing unit, a track determining unit, and a transmitting unit. The refill includes a nib and a distal end. The light emitting unit emits light on a writing medium. The light sensing unit captures images on the writing medium and analyzes the images to obtain a track of the nib. The pressure sensing unit senses whether the nib writes on the writing medium. The track determining unit determines a writing track based on the track of the nib and a sensing result of the pressure sensing unit. The transmitting unit transmits the writing track to an electronic device. The writing track is used to determine an input operation of the electronic device.

### CROSS-REFERENCE TO RELATED APPLICATIONS

This application claims priority to Chinese Patent Application No. 201410551434.0, filed on Oct. 17, 2014, the contents of which are incorporated by reference herein.

### FIELD

The present disclosure relates to a handwriting input device of an electronic device.

### BACKGROUND

Electronic devices, for example computers and mobile phones, allow input of characters using a keyboard. People must know how to operate a keyboard to input the characters. Thus, people who do not know how to operate a keyboard cannot input characters.

### BRIEF DESCRIPTION OF THE DRAWINGS

Implementations of the present technology will now be described, by way of example only, with reference to the attached figures.

FIG. 1 is a cross sectional view of a handwriting input device of an electronic device.

FIG. 2 is a block diagram of the handwriting input device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “outside” refers to a region that is beyond the outermost confines of a physical object. The term “comprising” means “including, but not necessarily limited to”; it specifically indicates open-ended inclusion or membership in a so-described combination, group, series and the like.

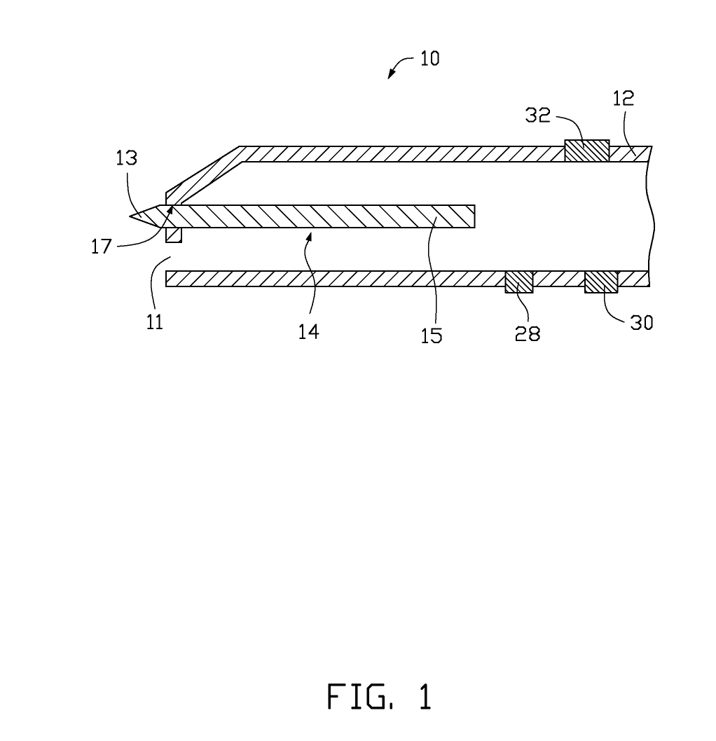

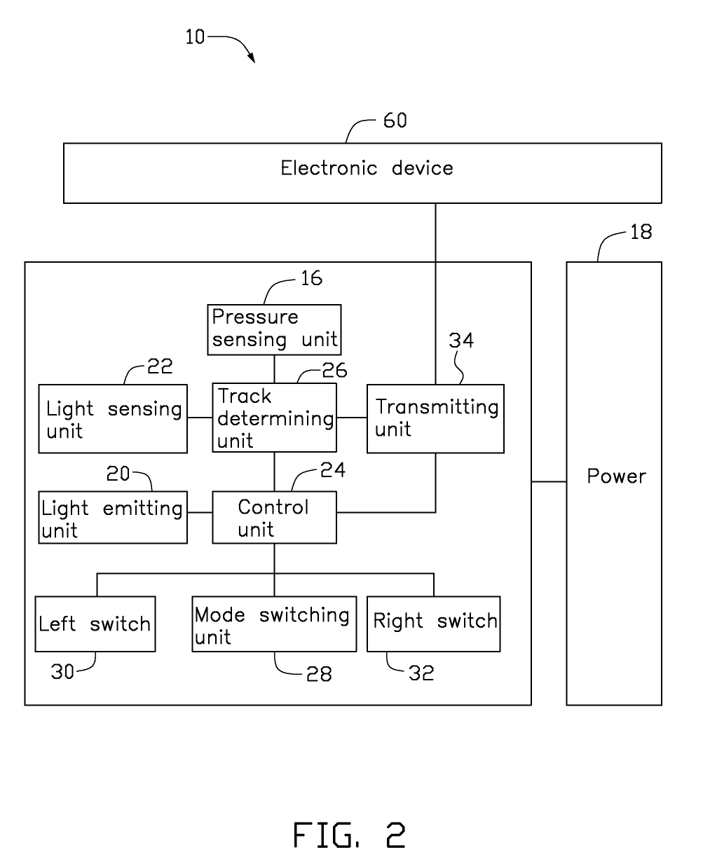

FIGS. 1 and 2 illustrate a handwriting input device 10 communicating with an electronic device 60. The handwriting input device 10 is configured to input words and is operate as a mouse to control the electronic device. The handwriting input device 10 includes a shell 12, a refill 14, a pressure sensing unit 16, a power 18, a light emitting unit 20, a light sensing unit 22, a control unit 24, a track determining unit 26, a mode switching unit 28, a left switch 30, a right switch 32 and a transmitting unit 34.

One end of the shell 12 defines a first through hole 17 and a second through hole 11. The refill 14 includes a nib 13 and a distal end 15 away from the nib 13. The nib 13 passes through the first through hole 17 to be positioned outside of the shell 12. The nib 13 is configured to write on a writing medium. The writing medium can be paper, a screen, or any other surface. The distal end 15, the pressure sensing unit 16, the power 18, the light emitting unit 20, the light sensing unit 22, the control unit 24, and the track determining unit 26 are all positioned in the shell 12. The light emitting unit 20 and the light sensing unit 22 face the second through hole 11. The mode switching unit 28, the left switch 30, the right switch 32 and the transmitting unit 34 are positioned on sidewalls of the shell 12.

The mode switching unit 28 is configured to change the mode of the handwriting input device 10 to be in one of a writing mode, a mouse mode, or a shutdown mode. When the handwriting input device 10 is in the input mode, the handwriting input device 10 is configured to input words to the electronic device 60. When the handwriting input device 10 is in the mouse mode, the handwriting input device 10 is configured to be operated as a mouse of the electronic device 60. When the handwriting input device 10 is in the shutdown mode, the handwriting input device 10 does not works.

The control unit 24 is configured to control the power 18 to provide power to the light emitting unit 20 when the handwriting input device 10 is in the input mode or in the mouse mode. The light emitting unit 20 is configured to emit light on the writing medium. The light emitting unit 20 is a laser emitting unit. The light sensing unit 22 is configured to capture and analyze images at a predetermined rate on the writing medium to obtain a track of the nib 13.

The pressure sensing unit 16 is positioned on the distal end 15. The pressure sensing unit 16 is configured to sense whether the nib 13 writes on the writing medium. When the nib 13 writes on the writing medium, the pressure sensing unit 16 senses a pressing force. When the nib 13 does not write on the writing medium, the pressure sensing unit 16 senses no pressing force. That is, when the pressure sensing unit 16 senses a pressing force, the nib 13 is writing on the writing medium, and when the pressure sensing unit 16 senses no pressing force, the nib 13 is not writing on the writing medium.

When the handwriting input device 10 in the writing mode, a track on the writing medium wrote by the nib 13 is needed to be displayed on the electronic device 60. When the nib 13 leaves the writing medium, a track in the air determines the position of another starting point of a word. Thus, the track in the air may not be displayed on the electronic device 60.

When the handwriting input device 10 is in the writing mode, the track determining unit 24 is configured to determine a writing track on the writing medium based on a result of the pressing force sensed by the pressure sensing unit and the track of the nib 13, and a moving track in the air tracks when the nib leaves the writing medium to when the nib writes on the writing medium again based on the result of the pressing force sensed by the pressure sensing unit and the track of the nib 13. The transmitting unit 34 is configured to transmit the writing track and a writing signal to the electronic device 10, and transmit the moving track and a non-writing signal to the electronic device 10. In the embodiment, the handwriting input device 10 can communicate with the electronic device 10 by Bluetooth. The transmitting unit 34 can be a Bluetooth interface.

The electronic device 10 is configured to control a cursor of the electronic device 10 to move following the writing track and display the writing track on the electronic device 10 according to the writing track and a writing signal, and control the cursor of the electronic device 10 to move following the moving track to position a starting point of a word according to the moving track and the non-writing signal.

When the handwriting input device 10 is in the mouse mode, the track on the writing medium wrote by the nib 13 is to be positioned a target point to operate the electronic device 10. Thus, the track on the medium is obtained, but is not to be displayed on the electronic device 10. When the nib 13 leaves the writing medium, the track in the air can be any track so as to allow for a convenient position for further operation. Thus, the track in the air is not required.

When the handwriting input device 10 is in the mouse mode, the track determining unit 24 is configured to determine a sliding track on the writing medium based on the result of the pressing force sensed by the pressure sensing unit and the track of the nib 13. The transmitting unit 34 is further configured to transmit the sliding track and a sliding signal to the electronic device 10. The electronic device 10 is further configured to control the cursor of the electronic device 10 to move following the sliding track on the electronic device 10 according to the sliding track and the sliding signal.

The left switch 30 is configured, when the handwriting input device 10 is in the mouse mode, to send a left key function signal in response to an operation by an operator. The right switch 32 is configured, when the handwriting input device 10 is in the mouse mode, to send a right key function signal in response to an operation of an operator. The transmitting unit 34 is further configured to transmit the left key function signal and the right key function signal to the electronic device 60. The electronic device 60 is further configured to activate a function similar to a left key of a mouse according to the left key function signal, and activate a function similar to a right key of a mouse according to the right key function signal.

The handwriting input device 10 can write on any writing medium to input words to the electronic device 10 and can be operated as a mouse to control the electronic device 10.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. A handwriting input device comprising:
a shell;
a refill comprising a nib and a distal end opposite the nib, the nib configured to write on a medium and positioned outside of the shell;
a light emitting unit configured to emit light on the medium;
a light sensing unit configured to capture images at a predetermined rate on the writing medium and analyze the images to obtain a track of the nib;
a pressure sensing unit configured to sense whether the nib is in contact with the medium;
a track determining unit configured to determine a writing track based on the track of the nib and a sensing result of the pressure sensing unit when the handwriting input device is in a writing mode, which is used to input words to an electronic device communicating with the handwriting input device; and
a transmitting unit configured to transmit the writing track to the electronic device, the writing track being used to determine an input operation of a cursor of the electronic device.

2. The handwriting input device as claimed in claim 1, wherein the track determining unit is further configured to determine a moving track in the air from when the nib leaves the writing medium to when the nib writes again on the writing medium based on the sensing result of the pressure sensing unit and the track of the nib.

3. The handwriting input device as claimed in claim 1, wherein the pressure sensing module is positioned on the distal end.

4. The handwriting input device as claimed in claim 1, wherein the transmitting unit is a Bluetooth interface.

5. The handwriting input device as claimed in claim 1, wherein the shell defines a through hole adjacent to the nib, the light emitting unit and the light sensing unit are both positioned in the shell and faces the through hole.

6. The handwriting input device as claimed in claim 1, wherein the handwriting input device further comprises a shutdown mode and a power, when the handwriting input device is in the writing mode, the power provides power to the light emitting unit to emit light, when the handwriting input device is in the shutdown mode, the power does not provide power to the light emitting unit.

7. The handwriting input device as claimed in claim 1, wherein the light emitting unit is a laser emitting unit.

8. The handwriting input device as claimed in claim 1, wherein the handwriting input device further comprises a mouse mode, the track determining unit is further configured to determine a sliding track on the writing medium based on the sensing result of the pressure sensing unit and the track of the nib, the transmitting unit is further configured to transmit the sliding track to the electronic device, the sliding track is used to determine a move operation to position the cursor of the electronic device.

9. The handwriting input device as claimed in claim 8, wherein the handwriting input device further comprises a left switch, the left switch is configured to send a left key function signal in response to an operation when the handwriting input device is in the mouse mode, the left key function signal is configured to control the electronic device to activate a function similar to a left key of a mouse.

10. The handwriting input device as claimed in claim 8, wherein the handwriting input device further comprises a right switch, the right switch is configured to send a right key function signal in response to an operation when the handwriting input device is in the mouse mode, the right key function signal is configured to control the electronic device to activate a function similar to a right key of a mouse.

11. An electronic pen comprising a plurality of modes, the electronic pen comprising:
a refill comprising a nib, the nib configured to write on a writing medium;
a light emitting unit configured to emit light on the writing medium;
an image capturing unit configured to frequently capture images on the writing medium and analyze the images to obtain a track of the nib;
a pressure sensing unit configured to sense whether the nib writes on the writing medium;
wherein one of the plurality of modes is a writing mode for inputting words to an electronic device;
a track determining unit configured to determine a writing track based on the track of the nib and a sensing result of the pressure sensing unit when the handwriting input device is in the writing mode; and
a transmitting unit configured to transmit the writing track to the electronic device, the writing track as a basis to input a word to the electronic device.

12. The electronic pen as claimed in claim 11, wherein the track determining unit is further configured to determine a moving track in the air from when the nib leaves the writing medium to when the nib writes again on the writing medium based on the sensing result of the pressure sensing unit and the track of the nib.

13. The electronic pen as claimed in claim 11, wherein the pressure sensing module is positioned on a distal end of the refill opposite the nib.

14. The electronic pen as claimed in claim 11, wherein the transmitting unit is a Bluetooth interface.

15. The electronic pen as claimed in claim 11, further comprising a shell surrounding the refill, the shell defining a through hole adjacent to the nib, the light emitting unit and the light sensing unit both positioned in the shell and faces the through hole.

16. The electronic pen as claimed in claim 11, wherein another mode is a shutdown mode, the electronic pen further comprises a power, when the electronic pen is in the writing mode, the power provides power to the light emitting unit to emit light, when the electronic pen is in the shutdown mode, the power does not provide power to the light emitting unit.

17. The electronic pen as claimed in claim 11, wherein the light emitting unit is a laser emitting unit.

18. The electronic pen as claimed in claim 11, wherein another mode is a mouse mode, the track determining unit is further configured to determine a sliding track on the writing medium based on the sensing result of the pressure sensing unit and the track of the nib, the transmitting unit is further configured to transmit the sliding track to the electronic device, the sliding track is used to determine a move operation to position the cursor of the electronic device.

19. The electronic pen as claimed in claim 18, wherein the electronic pen further comprises a left switch, the left switch is configured to send a left key function signal in response to an operation when the handwriting input device is in the mouse mode, the left key function signal is configured to control the electronic device to activate a function similar to a left key of a mouse.

20. The electronic pen as claimed in claim 18, wherein the electronic pen further comprises a right switch, the right switch is configured to send a right key function signal in response to an operation when the handwriting input device is in the mouse mode, the right key function signal is configured to control the electronic device to activate a function similar to a right key of a mouse.
